(19) United States
(12) Patent Application Publication
(10) Pub. No.: US 2014/0064479 A1
(43) Pub. Date: Mar. 6, 2014

(54) METHOD AND SYSTEMS FOR MULTILEVEL DATA SECURITY

(71) Applicant: Samsung Electronics Co., Ltd, Gyeonggi-do (KR)

(72) Inventors: M. Sabarimalai Manikandan, Tamilnadu (IN); Saurabh Tyagi, Uttar Pradesh (IN)

(73) Assignee: Samsung Electronics Co., Ltd, Gyeonggi-do (KR)

(21) Appl. No.: 14/020,760

(22) Filed: Sep. 6, 2013

(30) Foreign Application Priority Data
Sep. 6, 2012 (IN) 2783/DEL/2012

(51) Int. Cl. H04L 9/28

(52) U.S. Cl. CPC H04L 9/28
USPC 380/28

(57) ABSTRACT

Device and method for multi-level dynamic joint data security and compression are disclosed. The method includes receiving an input signal from a sensor interface, performing encryption on compressive measurement encoded data that is based on the input signal, transmitting the encrypted compressive measurement encoded data through a communication network, performing decryption on the encrypted compressive measurement encoded data after receiving the encrypted compressed measurement encoded data from the communication network to form decrypted compressive measurement decoded data, and reproducing an original signal from the decrypted compressive measurement decoded data that corresponds to the input signal.

### CROSS-REFERENCE TO RELATED APPLICATION(S) AND CLAIM OF PRIORITY

The present application is related to and claims priority under 35 U.S.C. §119 to an application filed in India with Intellectual Property INDIA on Sep. 6, 2012 and assigned Serial No. IN 2783/DEL/2012, the contents of which are incorporated herein by reference.

### TECHNICAL FIELD

The present invention generally relates to data security and cryptography, and more particularly to methods and systems for securing data from unauthorized access.

### BACKGROUND

As data communication becomes more pervasive and complex with evermore wide spread use, data security becomes a wider, more complex and more important problem. Since the digital data in communication channels and distributed storage devices is inherently exposed to public users through network connectivity, the storage and communication services are becoming more and more vulnerable to security threats. Securing and protecting valuable multimedia and non-multimedia data on-the-fly becomes increasingly more demanding for commercial and personal communication applications. Several cryptographic techniques are used to encrypt and decrypt the data but have to achieve a tradeoff between channel bandwidth, robustness, and complexity. Existing methods require data compression techniques to be applied before data encryption as uncompressed data requires large storage space, is not cost effective, and requires very high channel bandwidth for data transfer over a network.

Existing methods employ two-stage approach of compressing data and then encrypting this compressed data. These methods have higher computational complexities and require more memory space. The computational complexity and memory requirements of the data security system heavily depend on requirements of both compression and cryptographic techniques. It is not possible to use the above techniques in a cascaded manner without considering the impact of one technique over another. The data security methods using scrambling techniques that are implemented in temporal, spatial and frequency domains are neither effective nor efficient for storing or transmitting signals as these approaches significantly change the characteristics of the original signal. Thus, compression of data is not achieved, demanding high bandwidth for transmission and more memory space for data storage. Conventional data scrambling techniques in the spatial (or temporal or frequency) domain provide limited possibilities of scrambled data and allow easy attack on security of data. Moreover, existing security techniques are not fast enough to process multimedia data collected via sensors and monitoring systems to meet the real-time constraints.

Due to above mentioned reasons, existing data security systems fail to provide sufficient data security with high compression efficiency for storage and transmission. Also, it does not provide an effective solution for reducing the computing resources, transmission channel bandwidth, power consumption and processing time.

### SUMMARY

To address the above-discussed deficiencies of the prior art, it is a primary object to achieve devices, methods and systems for joint data security and compression in compressive measurement domain.

Another object of embodiments of the present disclosure is to provide multilevel dynamic data security without substantially increasing computing and bandwidth resources giving an energy-efficient system.

Accordingly certain embodiments of the present disclosure provide a method for multi-level dynamic joint data security and compression, the method includes receiving an input signal from a sensor interface, performing encryption on compressive measurement encoded data that is based on the input signal, transmitting the encrypted compressive measurement encoded data through a communication network, performing decryption on the encrypted compressive measurement encoded data after receiving the encrypted compressed measurement encoded data from the communication network to form decrypted compressive measurement decoded data, and reproducing an original signal from the decrypted compressive measurement decoded data that corresponds to the input signal.

Accordingly certain embodiments of the present disclosure provide a compressive encoding system for encoding an input signal, the compressive encoding system is configured to receive the input signal from a sensor interface, generate at least one secret key, perform compressive measurement on the input signal to form a compressive measurement signal, apply dynamic scrambling on the compressive measurement signal using the at least one secret key to form a scrambled compressive measurement signal, apply quantization on the scrambled compressive measurement signal to form a quantized compressive measurement signal, apply encoding on the quantized compressive measurement signal to form an encoded compressive measurement signal, apply interleaving on the encoded compressive measurement signal using the at least one secret key to form an interleaved encoded compressive measurement signal, combine the interleaved encoded compressive measurement signal and the at least one secret key that has been encrypted.

Accordingly certain embodiments of the present disclosure provide a transmission system for transmitting encrypted compressive measurement encoded data, the transmission system is configure to receive the encrypted compressive measurement encoded data from compressive encoding system and transmit the encrypted compressive measurement encoded data to a receiving system.

Accordingly certain embodiments of the present disclosure provide a storage system for storing encrypted compressive measurement encoded data, the storing system is configured to store the encrypted compressive measurement encoded data received from a compressive encoding system.

Accordingly certain embodiments of the present disclosure provide a compressive decoding system for decoding encrypted compressive measurement encoded data from a communication network, the compressive decoding system is configured to receive the encrypted compressive measurement encoded data with at least one encrypted secret key, decrypt the received at least one encrypted secret key by decryption module and decrypt the encrypted compressive measurement encoded data to form an interleaved compressive measurement signal, apply deinterleaving on the interleaved compressive measurement signal using the decrypted secret key to form a deinterleaved compressive measurement signal, apply decoding on the deinterleaved compressive measurement signal to form a decoded compressive measurement signal, apply dequantization on the decoded compressive measurement signal to form a dequantized compressive measurement signal, apply dynamic descrambling to the dequantized compressive measurement signal using the at least one decrypted secret key to form a descrambled compressive measurement signal, applying a sparse recovery process to the descrambled compressive measurement signal to form a compressed encoded signal, and reproduce an original form of the compressed encoded signal corresponding to an input signal.

Accordingly certain embodiments of the present disclosure provide a device for multi-level dynamic joint data security and compression, the device configured with an integrated circuit further including at least one processor, at least one memory having a computer program code within the circuit, the at least one memory and the computer program code configured to, with the at least one processor, cause the device to receive an input signal from a sensor interface, perform encryption on compressive measurement encoded data that is based on the input signal to form encrypted compressive measurement encoded data, transmit the encrypted compressive measurement encoded data through a communication network, perform decryption on the encrypted compressive measurement encoded data after receiving the encrypted compressive measurement encoded data from the communication network to form decrypted compressive measurement decoded data, and reproduce an original signal from the decrypted compressive measurement decoded data that corresponds to the input signal.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a data communication and storage system, in accordance with certain embodiments of the present disclosure;

FIG. 2 illustrates a multilevel dynamic joint data security and coding system using compressive sensing and sparse recovery techniques, in accordance with certain embodiments of the present disclosure;

FIG. 3 illustrates a multilevel dynamic joint data security and coding system using compressive sensing and sparse recovery techniques and storing encrypted data, in accordance with certain embodiments of the present disclosure;

FIG. 4 is a flow diagram illustrating a process of compressive sensing encoding system, in accordance with certain embodiments of the present disclosure;

FIGS. 5A-5D are block diagrams illustrating different scrambling operations, in accordance with certain embodiments of the present disclosure;

FIG. 6 is a flow diagram illustrating a process of compressive decoding system, in accordance with certain embodiments of the present disclosure; and

FIG. 7 is a graph illustrating performance of compressive sensing based secured data processing system, in accordance with certain embodiments of the present disclosure.

### DETAILED DESCRIPTION

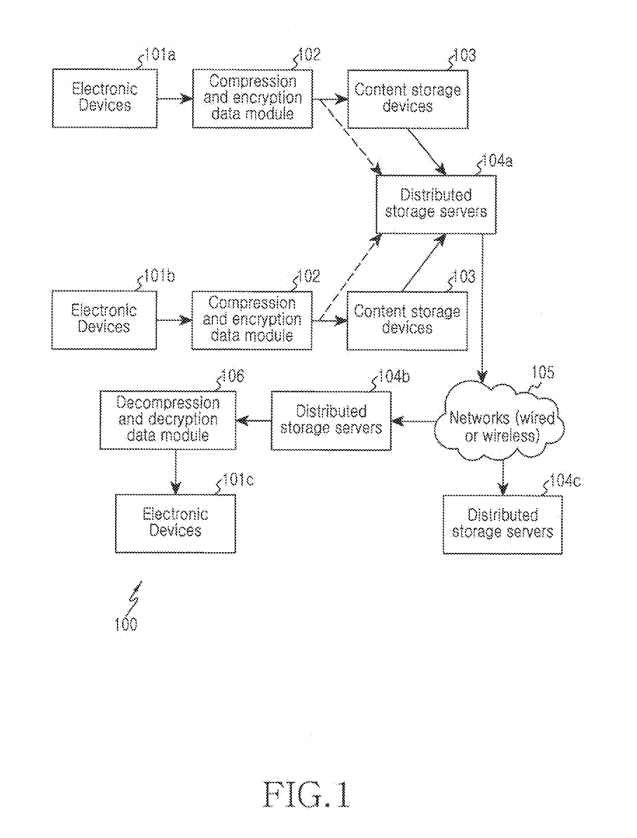

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged data system. The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve methods and systems to perform multilevel dynamic joint data compression and security, in the compressive measurement domain without substantially increasing computing and bandwidth resources. The system uses the concepts of compressive sensing and sparse signal representation techniques making it simpler and more energy efficient. The system provides a compressive encoder which can perform functions such as compressive sampling, dynamic scrambling, quantization, encoding and dynamic interleaving and so on. The input data uses random secret keys before storage or transmission. The system also provides a compressive decoder which can perform functions such as dynamic de-interleaving, decoding, de-quantization, dynamic descrambling, sparse signal reconstruction, and so on to reconstruct an original signal from received data using the secret keys received from the encoder that corresponds to an input signal. The system uses any of the wired or wireless communication interface and application protocol for data transmission and reception. The above enhanced functions of system provide simultaneous data security and compression on-the-fly so as to be useful in real time signal processing.

Compressive Sensing (CS) is a powerful and advanced signal processing technique in data acquisition theory that aims to approximate a signal using a few measurements in a sparse representation matrix by exploiting the signal's compressibility or sparsity when acquiring/sensing the signal. However, this simple technique for encrypting the random seed used for generation of a compressive sensing matrix may not provide better security of data since partial data can be retrieved when unauthorized users employ some other random seed. The method and system disclosed overcomes this drawback by using compressive sensing and sparse signal reconstruction techniques to provide joint compression and security (encryption and decryption) on the data. The theory of sparse recovery (or sparse signal representation) mentions that, most natural signals can be represented as a linear combination of a small number of elementary waveforms (or atoms) chosen from a predefined dictionary matrix q with their corresponding weights as given in equation below:

$$x = {\sum }_{n = 1}^{N} {α}_{n} {ψ}_{n} = Ψα , \qquad ( 1 )$$

Where α=[α₁, α₂, . . . α_{N-1}, α_{N}] the transform sparse coefficients vector that is computed as αₙ= [symbol] x,ψₙ [symbol] . The theory of compressive sensing, as introduced by Candes, Tao, and Romberg and Donoho, demonstrates that a K-sparse signal in sparse basis matrix Ψ can be reconstructed from a fixed set of linear measurements. Consider an M×N measurement/sensing basis matrix Φ, where the rows of measurement matrix Φ are incoherent with the columns of sparse basis matrix Ψ. The compressive measurement system computes the measurements as given below:

y=Φx, (2)

where y represents an M×1 measurement/sampled vector and x is the input signal vector which can be represented as x=Ψα. Generally, the measurement system performs dimensionality reduction. These measurements are able to completely capture the useful content embedded in a sparse signal. The expression for compressive measurement system can be rewritten as follows

y=Φ·Ψ·α=A·α, (3)

where A=ΦΨ is an M×N matrix. The method and system provides secure coding and transmission or storage of the measurement data vector y obtained from input signal x.

Throughout the description the terms compressive sensing, compressive sampling, compressive measurement, compressed sensing, compressed sampling is used interchangeably.

Throughout the description the terms data security and data encryption/decryption is used interchangeably.

Throughout the description the terms data and signal is used interchangeably.

Referring now to the drawings, and more particularly to FIGS. 1 through 7, where similar reference characters denote corresponding features throughout the figures, there are shown preferred embodiments.

FIG. 1 illustrates general block diagram of a data communication and storage system 100, in accordance with certain embodiments of the present disclosure. FIG. 1 includes electronic devices 101a, 101b, and 101c, a compression and encryption data module 102, content storage devices 103, distributed storage servers 104a, 104b, and 104c, a network 105, a decompression and decryption data module 106. The data communication and storage system 100 provides joint data compression and encryption, joint data decompression and decryption techniques, used by data security system for protection of data against unauthorized access. The compression and encryption data module 102 receives data from electronic devices 101a and 101b.

In an embodiment, electronic devices can be mobile phones, tablets, laptops, personal digital assistant (PDA), desktop computers, notebooks, wearable devices, and so on. The compression and encryption data module 102, on receiving data from electronic devices 101a and 101b, performs signal processing such as compression, encryption, and data integrity on the received data. System 100 provides mechanism to simultaneously perform compression and encryption on the data in the compression and encryption data module 102 and to obtain fast signal processing of data collected through sensors. This system meets real time constraints without substantially increasing computing resources and bandwidth requirement.

The compressed and the encrypted data from the compression and encryption data module 102 can securely be transmitted over a communication network. This compressed and encrypted data can be stored on content storage devices 103 and then can be transmitted to distributed storage server 104a or can directly be transmitted to be stored on distributed storage server 104a. Further, the encrypted and compressed data can be transmitted to any of the desired electronic devices, such as electronic device 101c, through a secured wired or wireless communication network 105 and/or a distributed storage server 104b. The data can also be transmitted through network 105 to another distributed storage server 104c in the network. In an embodiment, communication network can be a network, such as mobile cellular networks, cable television networks, wireless networks, internet, cognitive radio networks, wireless sensor networks, satellite networks, Wi-Fi, wireless local loop (WLL), WLAN, Bluetooth, Zigbee, global positioning system (GPS), cloud computing, and so on.

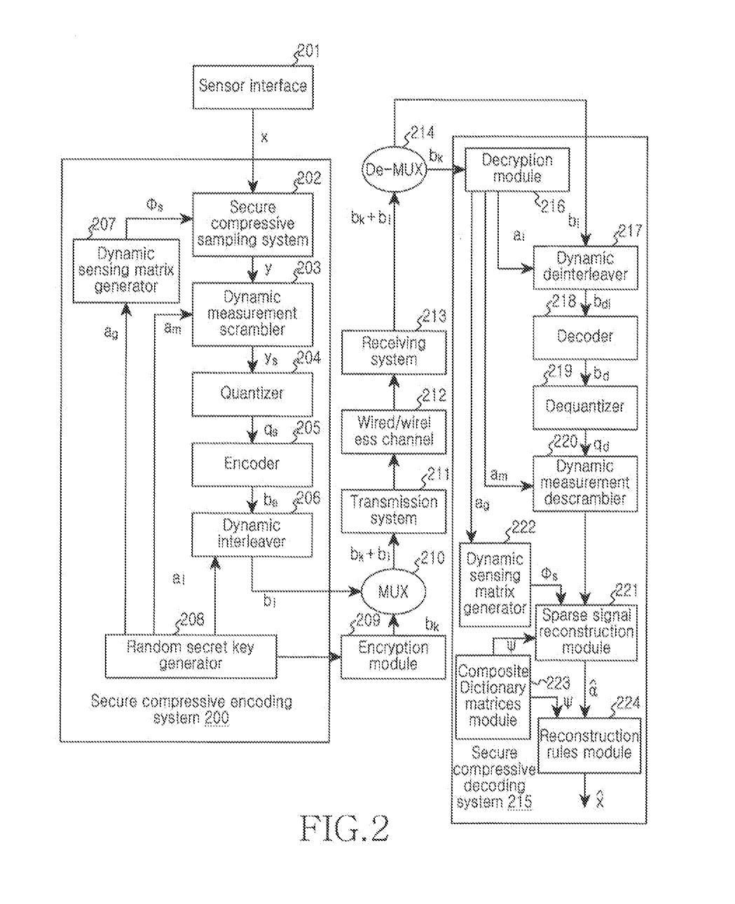

FIG. 2 illustrates a multilevel dynamic joint data security and coding system using compressive sensing and sparse recovery techniques, in accordance with certain embodiments of the present disclosure. The FIG. 2 shows sensor interface 201, a secure compressive encoding system 200 including secure compressive sampling system 202, a dynamic measurement scrambler 203, a quantizer 204, an encoder 205, a dynamic interleaver 206, a dynamic sensing matrix generator 207, and a random secret key generator 208. Further, the multilevel dynamic joint data security and coding system includes an encryption module 209, a multiplexer (MUX) 210, a transmission system 211, a wired or wireless communication channel 212, a receiving system 213, and a demultiplexer (De-Mux) 214. A secure compressive decoding system 215 includes a decryption module 216, a dynamic deinterleaver 217, a decoder 218, a dequantizer 219, a dynamic measurement descrambler 220, a sparse signal reconstruction module 221, a dynamic sensing matrix generator 222, a composite dictionary matrices module 223, and a signal reconstruction module 224.

The compressive sensing encoding system 200 determines data compression efficiency and ensures multilevel data security. The devices and techniques integrated with compressive sensing encoding system 200 convert the input signal x into measurements. Sensor interface 201 senses signals which need to be secured and compressed. Input signal x can be single or multidimensional signal and can be either an analog or a digital signal. Input signal x from sensor interface 201 will be processed in secure compressive sampling system 202 using scrambled compressive sensing matrix Φₛ generated by dynamic sensing matrix generator 207 for randomly selected random secret key a_{g} generated by random secret key generator 208. This random secret key a_{g} used by scrambled compressive sensing matrix Φₛ provides first level of security dynamically. The analog compressive sensing device or digital compressive sensing device is used depending on a type of input signal x.

In an embodiment, input signal x may be divided into predetermined segments and each segment may be processed according to techniques of compressive sensing method.

In an embodiment, a method for generating compressive sensing matrix may use Gaussian, Bernoulli, Walsh-Hadamard, Fourier basis, random basis, polynomial matrices, or any pseudo noise sequence generator. The method determines the number of measurements to be taken for an input signal by using information about the input signal to be processed at secure compressive sensing encoding system 200.

In an embodiment, the method may adaptively increase or decrease a number of measurements based on an acceptable reconstructed signal or data quality indicated by a user. In certain embodiments, a user can request secure compressive encoder 200 take a specific number of measurements. Thus, secure compressive sampling system 202 processes input signal x and outputs an encrypted compressive measurement sequence signal y to dynamic measurement scrambler 203. The dynamic measurement scrambler 203 uses the dynamic scrambling operations and secret key aₘ generated by random secret key generator 208 to determine a second level of security. Then, compressive measurement signal y will be scrambled using dynamically selected one or more scrambling operations, in order to increase a level of data security. The scrambling operational sequence is obtained based on secret key aₘ.

Output y of dynamic measurement scrambler 203 is provided to quantizer 204 for rounding the continuous set of measurement values with a finite precision set of values of quantization levels. Quantizer 204 represents the original signal with minimum loss or distortion when the quantized compressive measurements are used in the reconstruction.

In certain embodiments, quantization techniques can include one or more of a scalar midtread quantizer, a midrise quantizer, a non-uniform quantizer, an adaptive quantizer, a deadzone quantizer, a vector quantizer, and on the like. The method determines a number of quantization levels or a quantization step size based on a compression efficiency and an acceptable level of distortion in the reconstructed signal. Quantized output qₛ is provided to encoder 205 where an encoding process converts input decimal value of quantized output into a binary value. Encoded data bₑ is forwarded to dynamic interleaver 206 that performs dynamic interleaving process using the standard interleaving techniques.

Dynamic interleaver 206 processes the encoded data using one or more interleaving techniques that are implemented using one or more programs. Dynamic interleaver 206 uses secret key aᵢ generated by random secret key generator 208 for interleaving received data bₑ. The interleaving method provides a solution for reducing errors caused by bit errors in communication systems and provides a third level of security. The method provides the encryption module 209 for encrypting all secret keys generated by the random secret key generator 208. In certain embodiments, the encryption techniques can include one or more of a permutation and a modulo-2 operation, which are used to encrypt secret keys a_{g}, aᵢ, aₘ. The method mixes the interleaved data bᵢ and encrypted secret keys bₖ using multiplexing techniques at MUX 210. The encrypted secret keys bᵢ may be shared with authorized users when it is required.

Accordingly, the multiplexed data bₖ+bᵢ is transmitted using transmission system 211 through communication channel 212 a receiving system 213. Receiving system 213 receives data bₖ+bᵢ sent by transmission system 211 and performs demultiplexing of data bₖ+bᵢ using De-Mux 214 where received data of encrypted secret keys combined with interleaved data bₖ+bᵢ is separated. Encrypted keys bₖ are provided to decryption module 216 of secure compressive decoding system 215 for decrypting secret keys a_{g}, aₘ, aᵢ while interleaved data bᵢ is provided to the dynamic deinterleaver module 217 for deinterleaving by using reverse interleaving mapping techniques with received secret key aᵢ. Dynamic deinterleaver module 217 collects transmitted decrypted random key aᵢ, and then processes the interleaved data bᵢ to obtain the original deinterleaved data as it was at the input of dynamic interleaver 206. Deinterleaver 206 uses the reverse interleaving-mapping rules of interleaver 206 to restore the original sequence of data. The method can include one or more programs and devices to perform the deinterleaving process.

Deinterleaved data b_{di} is provided from deinterleaver 217 to decoder 218, which converts binary data into decimal data b_{d} and forwards data b_{d} to dequantizer 219 for performing de-quantization process on the decoded data to give dequantized data q_{d} using reverse de-quantization rules. The method includes one or more programs and devices for performing de-quantization process on the decoded measurement vector. The de-quantization process uses the specifications of the quantization process that are used at the secure compressive sensing encoding system 200. Dequantized data q_{d} goes to dynamic measurement descrambler 220 for descrambling the de-quantized measurements by using reverse dynamic scrambling operations with received secret key aₘ. The method has dynamic sensing matrix generator 222 generate scrambled compressive sensing matrix Φₛ using the received secret key a_{g}. The matrix Φₛ is provided to the sparse signal reconstruction module 221 such as to perform sparse signal representations by using L1-norm minimization algorithm or greedy algorithm. Further, sparse signal reconstruction module 221 can estimate sparse coefficients for the descrambled compressive measurements data and predetermined transform basis matrix Ψ (or representation matrix or sparse basis matrix). This transform basis matrix Ψ is generated by composite dictionary matrices module 223. Estimated coefficient vector â along with transform basis matrix Ψ is used by reconstruction rules module 224 to reconstruct original input signal x from estimated sparse coefficients â and the transform basis matrix Ψ.

In an embodiment, sparse basis matrix (or transform matrix) which may be constructed using elementary transforms of one or more of: Dirac, Heaviside, Fourier, short-time Fourier transform, discrete cosines, discrete sines, Haar, wavelets, wavelet packets, Gabor filters, curvelets, ridgelets, contourlets, bandelets, shearlets, directionlets, grouplets, chirplets, Walsh Hadamard, polynomials, and the like. The method can also use prior information about characteristics of an input signal or pattern of input signal to be processed at the encoding system side. By using prior information, the method may construct sparse basis matrix such that the complexity of the solving sparse recovery problem can be reduced.

In certain embodiments, input data x can be reconstructed from the descrambled measurements by solving the convex optimization problem with the sparse basis matrix and the scrambled sensing basis matrix Φₛ. The sparse basis matrix is selected such that it contains elementary transforms exhibiting strong similarities with the input signal to be transmitted or stored. The scrambled sensing basis matrix is obtained using the random matrix generator and the preferred dynamic scrambling operations listed in the scrambling operation sequence key shared at the decoding stage. The method processes the measurement vector and the matrix A=ΦₛΨ which is an M×N matrix, and produces estimated sparse transform coefficient vector â.

In certain embodiments, the method provides reconstructing input signal x by using estimated sparse transform coefficients and sparse basis matrix Ψ. For example, for a given input measurement vector y and dictionary matrix A, transform coefficients â are computed by solving the following minimization problem [Candes, Romberg, Tao; Donoho]:

$$\begin{matrix}min {‖ α ‖}_{1} subject to y = D α or & ( 4. a ) \\ min {‖ α ‖}_{1} subject to {‖ y - D α ‖}_{2} < ɛ or & ( 4. b ) \\ \hat{α} = {min}_{α} {‖ α ‖}_{1} + λ {‖ y - D α ‖}_{2}^{2} , & ( 4. c )\end{matrix}$$

where ∥α∥ₗ_{₁} and ∥α∥ₗ_{₂} represent the L1-norm and L2-norm of the vector, respectively, and λ is a regularization parameter that controls the relative importance of the fidelity and sparseness terms. Then, the input signal is recovered or reconstructed as \hat{x}=Ψ\hat{α}.

In certain embodiments, some functional operations are described as a method for de-mixing which is used to separate the bₖ+bᵢ when the encrypted secret keys are shared along with the input data, where bₖ represents encrypted keys, and bᵢ represents the encoded encrypted measurement data. The binary data bᵢ is then transferred to the dynamic deinterleaving section and the secret key data bₖ is transferred to the decryption section.

Some functional operations used in the preferred compressive sensing encoding system of the present disclosure are described below:

y=compressive_measurement(x,scrambled sensing matrix Φₛ) % generates measurements

s=scrambling_operation_sequence(secret_key); % generates random scrambling operations

ys=dynamic_scrambler(y,s) % scrambling compressive measurements

qs=quantizer(ys,step_size) % quantizing scrambled compressive measurements

be=encoder(qs) % converts decimal to binary numbers bi=dynamic_interleaver(be,secret_key) % interleaves the input data.

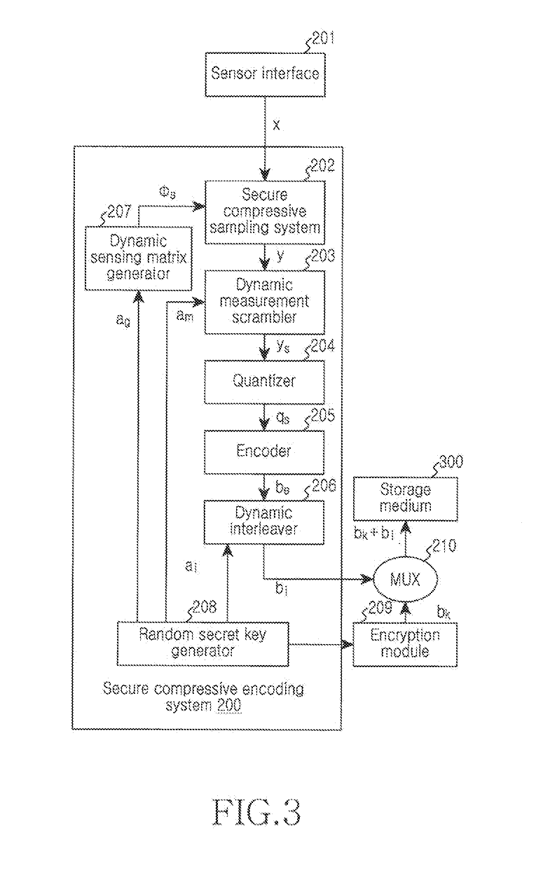

FIG. 3 illustrates a multilevel dynamic joint data security and coding system using compressive sensing and sparse recovery techniques and storing encrypted data, in accordance with certain embodiments of the present disclosure. FIG. 3 shows sensor interface 201, secure compressive encoding system 200 including secure compressive sampling system 202, dynamic measurement scrambler 203, quantizer 204, encoder 205, dynamic interleaver 206, dynamic sensing matrix generator 207, and random secret key generator 208. Further, the multilevel dynamic joint data security and coding system includes encryption module 209, multiplexer (MUX) 210 and storage medium 300.

The compressive sensing encoding system 200 determines data compression efficiency and ensures multilevel data security. The devices and techniques integrated with the compressive sensing encoding system 200 convert input signal x into measurements. Input signal x can be, for example, a multidimensional signal, an analog, or a digital signal. Input signal x received from the sensor interface 201 can be processed in secure compressive sampling system 202 using the scrambled compressive sensing matrix Φₛ generated by dynamic sensing matrix generator 207. The secure compressive sampling system 202 uses randomly selected random secret key a_{g} generated by random secret key generator 208. Random secret key a_{g} used by scrambled compressive sensing matrix Φₛ provides first level of security dynamically. The analog compressive sensing device or digital compressive sensing device is used depending on a type of input signal x.

In certain embodiments, the method may adaptively increase or decrease a number of measurements based on an acceptable reconstructed signal or data quality by a user. In certain embodiments, a user can request the secure compressive encoder take a specific number of measurements. Thus, secure compressive sampling system 202 processes input signal x and outputs encrypted compressive measurement sequence signal y to dynamic measurement scrambler 203 where the dynamic scrambling operations and the secret key aₘ generated by random secret key generator 208 will determine a second level of security. Then, compressive measurement signal y will be scrambled using one or more dynamically selected scrambling operations, in order to increase a level of data security. The scrambling operational sequence is obtained based on secret key aₘ.

Output y of dynamic measurement scrambler 203 is provided to quantizer 204 for rounding the continuous set of measurement values with a finite precision set of values of quantization levels. Quantizer 204 represents the original signal with minimum loss or distortion when the quantized compressive measurements are used in the reconstruction.

The method determines a number of quantization levels or a quantization step size based on a compression efficiency and an acceptable level of distortion in the reconstructed signal. The quantized output qₛ is provided to the encoder 205 where the encoding process converts input decimal value of quantized output into a binary value. Encoded data b_{c} is forwarded to dynamic interleaver 206 that performs dynamic interleaving process using standard interleaving techniques. The interleaving block processes the encoded data using one or more interleaving techniques that are implemented using one or more programs. Dynamic interleaver 206 uses secret key aᵢ generated by random secret key generator 208 for interleaving received data bₑ. The interleaving method provides a solution for reducing errors caused by bit errors in communication systems and provides a third level of security. The method provides encryption module 209 for encrypting all the secret keys generated by the random key generator 208. In certain embodiments, the encryption techniques can include one or more of a permutation and a modulo-2 operation, which are used to encrypt secret keys a_{g}, aᵢ, aₘ. The method mixes the interleaved data bᵢ and encrypted secret keys bₖ using the multiplexing techniques at MUX 210, and these encrypted keys may be shared with authorized users when it is required. This multiplexed data bₖ+bᵢ from MUX 210 which is a compressive encrypted encoded data is securely stored on a storage medium 300 and can be retrieved later. The storage medium 300 can be content storage devices 103, distributed storage server 104a, and the like. In an embodiment, this stored compressive encrypted encoded data can be later transmitted to any destination such as electronic device 101c, or distributed storage server 104c in the extended network and so on. The original input signal can be recovered using secure compressive decoding system 215.

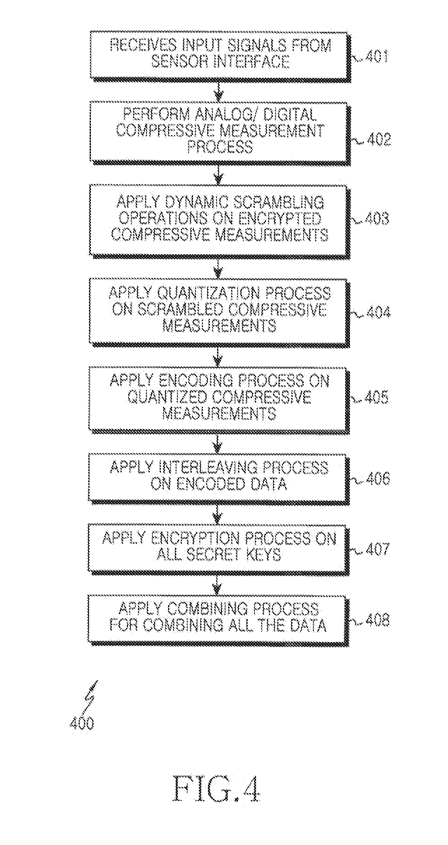

FIG. 4 illustrates a flow diagram explaining the process of compressive sensing encoding system, in accordance with certain embodiments of the present disclosure. As depicted in FIG. 400, secure compressive encoding system 200 receives (401) single or multidimensional input signal from sensor interface 201. In certain embodiments, sensor interface 201 can be attached with electronic devices such as 101a and 101b or from a storage database system, cloud computing system, and on the like. The received input signal can be an analog or a digital signal. On receiving the input signal secure compressive sampling system 202 performs (402) compressive measurement process using either analog compressive sensing device or digital compressive sensing device based on type of input signal. A scrambled compressive sensing matrix is used in the sensing process which provides compressed and encrypted data. Output data at secure compressive sampling system 202 is further provided to dynamic measurement scrambler 203, which applies (403) dynamic scrambling operations on encrypted compressive measurements where one or more scrambling operations are used in random manner as specified in a secret key generated by random secret key generator 208. The scrambled compressive measurements data is further forwarded to quantizer 204 which applies (404) preset quantization process on the scrambled compressive measurements to get finite precision set of data measurement values. The quantized data is provided to encoder 205 which applies (405) encoding process on quantized data received from quantizer 204. For example, lossless coding may applied by encoder 205 for further compression. This encoded data is provided to dynamic interleaver 205, which applies (406) interleaving process on encoded data received using dynamically selected predefined interleaving technique by using a secret key provided by random secret key generator 208. Further, encryption module 209 applies (407) encryption process on all secret keys used in the compressive sensing encoding process. The encoded signal data along with the encrypted keys are forwarded to MUX 210 which applies (408) combining process for combining all the data that may include header information, secret keys, interleaved data, and other information using one or more transmission or storage protocols. This combined data is further transmitted using transmission system 211 to reach the desired destination such as distributed storage device 104, content storage devices 103, or any other electronic devices such as electronic device 101c. The various actions in the method 400 may be performed in the order presented, in a different order or simultaneously. Further, in some embodiments, some actions listed in the FIG. 4 may be omitted.

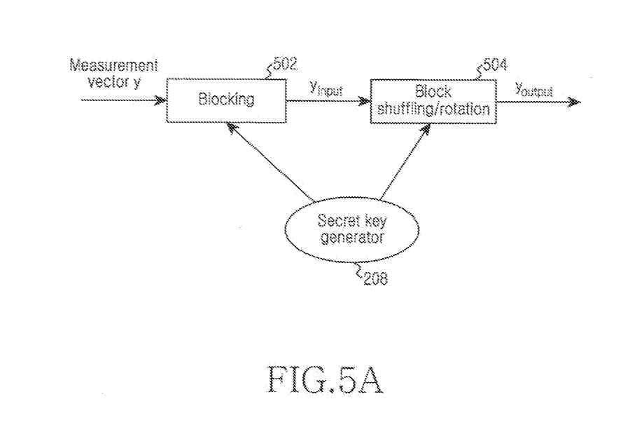

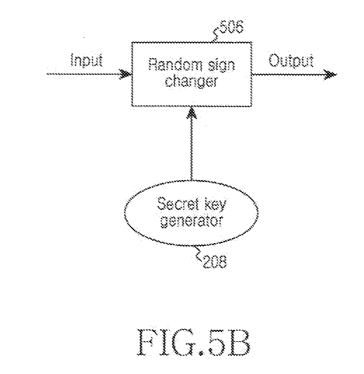

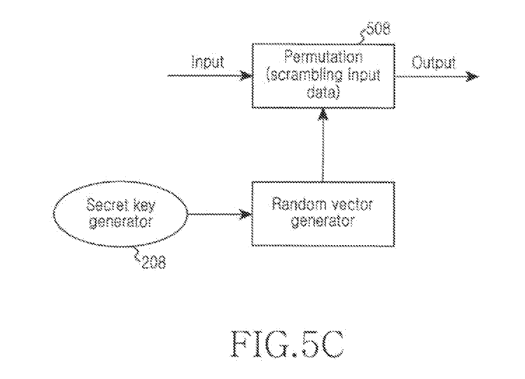

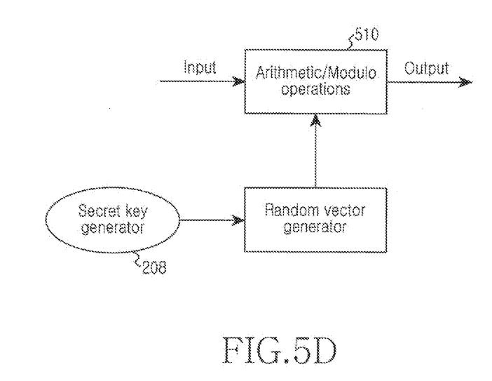

FIGS. 5A, 5B, 5C, and 5D illustrate block diagrams of different scrambling operations performed, in accordance with certain embodiments of the present disclosure. Certain scrambling operations, which can be performed on data by dynamic measurement scrambler module 203, in secure compressive encoding system 200, are depicted in FIGS. 5A, 5B, 5C, and 5D. Blocking module 502 of FIG. 5A present in the dynamic measurement scrambler 203 receives the measurement sequence data vector y from the secure compressive sampling system 202. This data vector y will be scrambled based on the randomly selected scrambling operations for secret key aₘ generated from random secret key generator 208. If y is the measurement vector of size M×1 for an N-dimensional input signal vector x then the structure of measurement vector y is shown below:

y={y[1], y[2], . . . , y[N−1], y[N]} (5)

The output of the measurement reversal operator is given below

y={y[N], y[N−1], . . . , y[2], y[1]} (6)

The block shuffling first divides the measurement vector y into non-overlapping blocks with variable size in the blocking module. The output of the block shuffling process is given below

y={b₁, b₂, . . . , b_{N}_{_{b}}}, (7)

where bₖ represents k^{th} block, and N_{b} represents the number of blocks.

The number of blocks and the sizes for the blocks will be randomly generated using secret key aₘ. For a selected number of blocks, the secret key for shuffling of blocks will be generated that provide positions for reordering the blocks. For example, the number of blocks is 5 and the sizes of blocks are {5, 10, 14, 2, 8}. For this specification, the total number of measurements is 39. Assume the secret key for block shuffling process is {3, 1, 4, 5, 2}. The input scrambled output structures of the block shuffling process are given below:

The input format:

yᵢₙₚᵤₜ={b₁,b₂,b₃,b₄,b₅} (8)

is provided to block shuffling/rotation module 504 and

The output format:

yₒᵤₜₚᵤₜ={b₃,b₁,b₄,b⁵,b₂} (9)

is obtained at the output which can further be provided to the quantizer 204.

In an embodiment, various other scrambling operations can be performed such as random sign changing operation 506 as in the FIG. 5B, permutation operation 508 as in the FIG. 5C, arithmetic modulo operation 510 as in the FIG. 5D using a secret key generated by the random secret key generator 208.

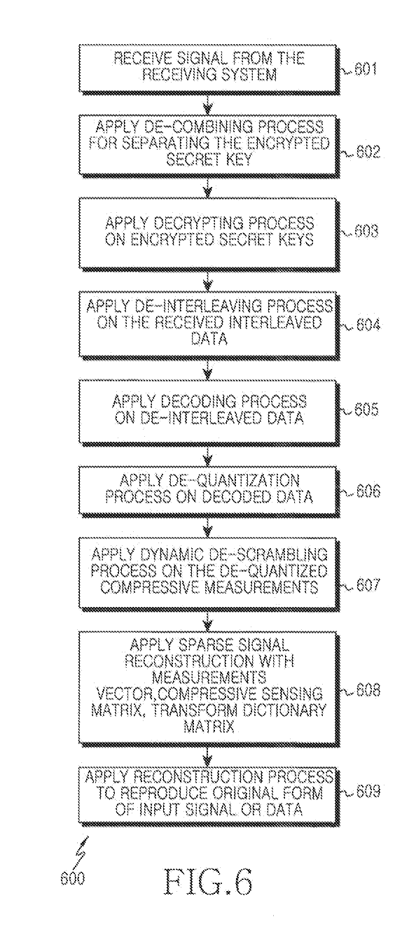

FIG. 6 illustrates a flow diagram 600 explaining the process of compressive decoding system, in accordance with certain embodiments of the present disclosure. As depicted in FIG. 6, the secure compressive decoding system 215 receives (601) a signal from receiving system 213 or a distributed storage system, such as distributed storage servers 104b. De-Mux 214 applies (602) the de-combining process for separating the encrypted secret key information and encoded data and if required can use the header information provided, according to transmission or storage protocols. This separated information related with encrypted keys is provided to the decryption module 216, which applies (603) decryption process on the encrypted secret keys by using information provided to the authorized users. The decrypted secret keys can be communicated to the corresponding processing units in the compressive sensing decoding system such as dynamic deinterleaver 217, dynamic measurement descrambler 220, and dynamic sensing matrix 222.

The data corresponding to compressive measurement which was separated at De-Mux 214 is provided to dynamic deinterleaver 217, which applies (604) de-interleaving process on the received interleaved data by using the reverse techniques adopted in the interleaving process by the secure compressive encoding system 200. Further, decoder 218 applies (605) decoding process on de-interleaved data which is then processed by dequantizer 219, which applies (606) de-quantization process on decoded data by using the reverse techniques of the quantization process adopted by quantizer 204 to produce de-quantized measurement values. To this dequantized compressive measurement data, dynamic measurement descrambler 220 applies (607) dynamic de-scrambling process by using the reverse techniques of the scrambling operations used by dynamic measurement scrambler 203.

The descrambled data is further provided to sparse signal reconstruction module 221, which applies (608) sparse recovery algorithms for estimating sparse coefficients \hat{α} using compressive sensing matrix Φₛ generated by dynamic sensing matrix generator 222 using secret key a_{g} received and transform dictionary matrix Ψ that produces a transform coefficient vector. The processed data is provided to reconstruction rules module 224 that applies (609) reconstruction process to reproduce original form of input signal x by using estimated coefficients \hat{α} and transform dictionary matrix Ψ. The reconstructed signal is obtained as: \hat{x}=Ψ\hat{α}. The various actions in method 600 may be performed in the order presented, in a different order or simultaneously. Further, in some embodiments, some actions listed in the FIG. 6 may be omitted.

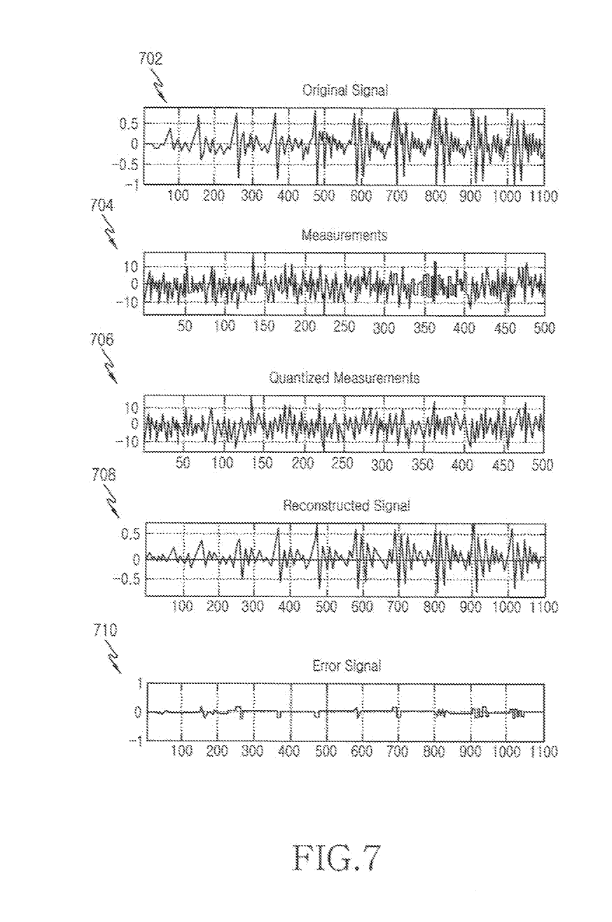

FIG. 7 illustrates the performance of the compressive sensing based secured data processing system, in accordance with certain embodiments of the present disclosure. FIG. 7 depicts graphical representation of the input signal at various output blocks. First graphical plot 702 represents original speech signal to be processed. Second graphical plot 704 represents measurements obtained using a secret key and scrambling sequence. Third graphical plot 706 represents quantized measurements at an output of a quantizer. Fourth graphical plot 708 represents a reconstructed signal using the compressive sensing decoding system with shared secret keys. Fifth graphical plot 710 represents an error signal obtained between original signal of plot 702 and reconstructed signal of plot 708. The input speech signal is processed using the scrambled sensing matrix and then the scrambled measurements are quantized. At a receiver section, the reverse operations of a compressive sampling encoder are applied to get the original measurements by using received secret keys. Then, the input signal is reconstructed using the L1-optimization as described above in the present disclosure. The reconstructed and error signals are plotted for visual tests. In this experiment, the parameters are: number of measurements=500, quantization bit=3, regularization parameter=0.1, the dictionary matrix has cosine basis functions). The experiment shows that the system can recover the input signal by using the random measurements and the L1-optimization minimization algorithm. Experimental studies on various signals and images prove system to be advantageous over existing systems. The error value shown has a very small deviation about zero which indicates a faithful reproduction of original signal at the output of compressive sensing decoder. Experimentation for performance check of the proposed method is validated using an electrocardiogram signal and speech signal.

The embodiments disclosed herein can be implemented through at least one software program running on at least one hardware device and performing network management functions to control the elements. The elements shown in the FIGS. 1, 2, 3, and 5 include blocks which can be at least one of a hardware device, or a combination of a hardware device and a software module.

The foregoing description of the specific embodiments disclose the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for multi-level dynamic joint data security and compression, the method comprising:
receiving an input signal from a sensor interface;
performing encryption on compressive measurement encoded data that is based on the input signal;
transmitting the encrypted compressive measurement encoded data through a communication network;
performing decryption on the encrypted compressive measurement encoded data after receiving the encrypted compressive measurement encoded data from the communication network; and
reproducing an original signal corresponding to the input signal from decrypted compressive measurement decoded data that is based on the decrypted compressive measurement encoded data.

2. The method of claim 1, wherein the sensor interface is attached to one or more of an electronic device, a storage database system, and a cloud computing system.

3. The method of claim 1 further comprising:
storing the encrypted compressive measurement encoded data in a storage device.

4. The method of claim 3, further comprising:
decrypting the encrypted compressive measurement encoded data from the storage device.

5. The method of claim 1, wherein the communication network comprises one or more of a wired channel and a wireless channel.

6. The method of claim 5, further comprising transmitting of the encrypted compressive measurement encoded data through the communication network after encrypting secret keys generated by a random secret key generator and used to compress and encode the input signal.

7. A compressive encoding system for encoding an input signal, wherein the compressive encoding system is configured to:
receive the input signal from a sensor interface;
generate at least one secret key;
perform compressive measurement on the input signal to form a compressive measurement signal;
apply dynamic scrambling on the compressive measurement signal using the at least one secret key to form a scrambled compressive measurement signal;
apply quantization on the scrambled compressive measurement signal to form a quantized compressive measurement signal;
apply encoding on the quantized compressive measurement signal to form an encoded compressive measurement signal;
apply interleaving on the encoded compressive measurement signal using the at least one secret key to form an interleaved encoded compressive measurement signal; and
combine the interleaved encoded compressive measurement signal and the at least one secret key that has been encrypted.

8. The compressive encoding system of claim 7, wherein the compressive encoding system is configured to receive the input signal in at least one of analog and digital form from the sensor interface, wherein the sensor interface is attached to one or more of an electronic device, a storage database system, and a cloud computing system.

9. The compressive encoding system of claim 7, wherein the performance of the compressive measurement further comprises generating a scrambled compressive sensing matrix using the at least one secret key to encrypt the compressive measurement signal to form an encrypted compressive measurement signal.

10. The compressive encoding system of claim 9, further configured to:
perform scrambling operations selected in a random manner on the encrypted compressive measurement signal.

11. The compressive encoding system of claim 9, further configured to:
adaptively control a number of compressive measurements of the input signal based on quality of a reproduced signal at a compressive decoding system, the reproduced signal corresponding to the input signal.

12. A transmission system for transmitting encrypted compressive measurement encoded data, wherein the transmission system is configured to:
receive the encrypted compressive measurement encoded data from a compressive encoding system; and
transmit the encrypted compressive measurement encoded data to a receiving system.

13. The transmission system of claim 12, wherein the transmission system is configured to transmit the encrypted compressive measurement encoded data through one or more of a wired communication network and a wireless communication network.

14. A storage system for storing encrypted compressive measurement encoded data, wherein the storing system is configured to:
store the encrypted compressive measurement encoded data received from a compressive encoding system.

15. A compressive decoding system for decoding encrypted compressive measurement encoded data from a communication network, the compressive decoding system configured to:
receive the encrypted compressive measurement encoded data with at least one encrypted secret key;
decrypt the received at least one encrypted secret key by a decryption module and decrypt the encrypted compressive measurement encoded data to form an interleaved compressive measurement signal;
apply deinterleaving on the interleaved compressive measurement signal using the at least one decrypted secret key to form a deinterleaved compressive measurement signal;
apply decoding on the deinterleaved compressive measurement signal to form a decoded compressive measurement signal;
apply dequantization on the decoded compressive measurement signal to form a dequantized compressive measurement signal;
apply dynamic descrambling to the dequantized compressive measurement signal using the at least one decrypted secret key to form a descrambled compressive measurement signal;
apply a sparse recovery process to the descrambled compressive measurement signal to form a compressed encoded signal; and
reproduce an original form of the compressed encoded signal corresponding to an input signal.

16. The compressive decoding system of claim 15 further configured to:
decombine the encrypted secret key and the encrypted compressive measurement encoded data.

17. The compressive decoding system of claim 15, wherein the sparse recovery process comprises using at least one of: dynamic a sensing matrix generator and a dictionary matrices module.

18. The compressive decoding system of claim 17, wherein the dynamic sensing matrix generator obtains at least one decrypted secret key from the decryption module.

19. The compressive decoding system of claim 15, wherein the sparse recovery process uses a sparse basis matrix that is adaptively constructed based on prior information of one or more of: characteristics of the input signal or one or more patterns of the input signal.

20. A device for multi-level dynamic joint data security and compression, wherein the device configured with:
an integrated circuit further comprising at least one processor;
at least one memory having a computer program code within the circuit;
the at least one memory and the computer program code configured to, with the at least one processor, cause the device to:
receive an input signal from a sensor interface;
perform encryption on compressive measurement encoded data that is based on the input signal to form encrypted compressive measurement encoded data;
transmit the encrypted compressive measurement encoded data through a communication network;
perform decryption on the encrypted compressive measurement encoded data after receiving the encrypted compressive measurement encoded data from the communication network to form decrypted compressive measurement decoded data; and
reproduce an original signal from the decrypted compressive measurement decoded data that corresponds to the input signal.

21. The device of claim 20, wherein the sensor interface is attached to at least one of electronic device, storage database system, cloud computing system.

22. The device of claim 20, wherein the device is configured to store the encrypted compressive measurement encoded data in a storage device.

23. The device of claim 22, wherein the device is configured to decrypt the encrypted compressive measurement encoded data from the storage device.

24. The device of claim 20, wherein the communication network comprises one or more of a wired communication network and a wireless communication network.

25. The device of claim 20, wherein the device is configured to transmit the encrypted compressive measurement encoded data through a communication network after encrypting one or more secret keys generated by a random secret key generator.
